(19) United States
(12) Patent Application Publication
(10) Pub. No.: US 2006/0201721 A1
(43) Pub. Date: Sep. 14, 2006

(54) Rotary propeller

(75) Inventor: Koki Fukuyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: New Scientific R&D Institute Inc., Tokyo (JP)

(21) Appl. No.: 11/360,890

(22) Filed: Feb. 23, 2006

(30) Foreign Application Priority Data
Mar. 9, 2005 (JP) 2005-65707

(51) Int. Cl. B62D 57/00

(52) U.S. Cl. 180/7.4

(57) ABSTRACT

Disclosed is a rotary propeller having a rotor 3 rotating in a duct 1 and a plurality of blades 5, 7 secured to the rotor. The blades comprise apertured blades 5A, 5B, 5C and non-apertured blades 7A, 7B, 7C, which are arranged alternately in a direction of rotation. One apertured blade 5 cooperates with adjacent two non-apertured blades 7 at opposite sides thereof to form a blade set G1, G2, G3. At an upstream area A, air streams S collide with said wind-receiving surface 15 and pass through the narrow holes 9 so that they are converted to jet streams J1 spouting from the holes 9. In an opposite, downstream area B, the non-apertured blade 7 functions as a partition to interrupt the flow of the air streams S, resulting in temporary stagnation of the air flows to produce voluminous air flows K moving at relatively slow flow rate. The jet streams J1 flowing out of the holes 9 entrain and join with the air flows K remaining in the area B to produce a second, larger jet flow J2. When the jet flow J2 spouts toward the exterior of the duct 1, there arises a greater thrust P.

### BACKGROUND OF THE INVENTION

1. Field of the Invention

The present invention relates to an improvement of a rotary propeller having a rotor rotating in a duct and a plurality of blades secured to the rotor, and more particularly to the rotary propeller which may generate greater thrust.

2. Description of the Prior Art

When manufacturing an aerial car or vehicle flying in the air, its body size and weight should be restricted. For an aerial car having a regular body size of a passenger car, a duct fan diameter is 800 mm or smaller and its revolution is in practice 4000 rpm or lower. Such design is only capable of generating thrust of about one third of that required to propel the car into the air. When a duct fan diameter is doubled, more improved thrust could be obtained, but the body size should become huge, like a bus. This is a main reason why an aerial car or vehicle has not yet been practiced on a commercial base.

### SUMMARY OF THE INVENTION

Accordingly, it is an object of the present invention to provide a rotary propeller of a novel construction which is capable of generating improved thrust.

To achieve the above and other objects, in accordance with the present invention, there is provided a rotary propeller having a rotor rotating in a duct and a plurality of blades secured to said rotor, characterized in that said blades comprise apertured blades and non-apertured blades, one apertured blade cooperating with adjacent two non-apertured blades at opposite sides thereof to form a blade set, jet streams passing through said holes of said apertured blade from an upstream area A of said blade set toward a downstream area B of said blade set, said jet streams entraining air streams in said downstream area B of said blade set to be spouted out of said duct.

There may be provided a plurality of said blade sets. In an embodiment, said apertured blades and said non-apertured blades are arranged alternately so that one non-apertured blade is an element of one blade set and at the same time is an element of another, adjacent blade set. In another embodiment, said blade set comprising one apertured blade and two non-apertured blades at opposite sides of said apertured blade are arranged separately.

In another preferred embodiment, said holes in said apertured blade are opened aslant with respect to a direction of rotation of said rotor.

In another preferred embodiment, each blade is secured to said rotor in such manner that a wind-receiving surface positioned upstream of a direction of rotation of sad blade is inclined with respect to a center axis of said rotor at an acute angle. Said acute angle may be about 30 degrees.

In another preferred embodiment, each blade is gradually widened toward a tip thereof.

In another preferred embodiment, each blade has a base of a triangular cross-section.

In another preferred embodiment, each blade has a tip of a triangular cross-section.

In another preferred embodiment, each blade has a base of a cross-section and a tip of another cross-section.

In another preferred embodiment, each blade is twisted about an axis extending in a lengthwise direction. Said axis may be a straight axis or a curved axis.

In another preferred embodiment, each apertured blade has a plurality of said holes.

In another preferred embodiment, said holes are opened in a three-dimensional manner.

### BRIEF DESCRIPTION OF THE DRAWINGS

Other objects and advantages of the present invention can be understood from the following description when read in conjunction with the accompanying drawings in which:

FIG. 1 is a front cross-sectional view diagrammatically showing a rotary propeller according to an embodiment of the present invention;

FIG. 2 is a cross-section taken along the lines II-II in FIG. 1 which shows the bottom portion of the rotary propeller;

FIG. 3 is an enlarged view showing a blade set G1 in FIG. 2;

FIG. 4 is an enlarged perspective view showing one apertured blade of the rotary propeller in FIG. 1;

FIG. 5(A) is a partial front view showing one apertured blade secured to a rotor, FIG. 5(B) is a plan view showing the arrangement in FIG. 5(A) and FIG. 5(C) comprises a set of cross-sections C1-C10 of the blade;

FIG. 6 is a graph showing relation between the blades and air streams; and

FIG. 7 is a deployment diagram of the rotor, which shows relation between respective blade sets and areas and also shows relation between airflows and thrust.

### DETAILED DESCRIPTION OF THE PREFERRED EMBODIMENT

A rotary propeller in accordance with the present invention will be described in detail in reference to the accompanying drawings which show a preferred embodiment of the invention. For the purpose of convenience, any part or element which has the same or similar functions is denoted by the same reference numeral throughout the drawings.

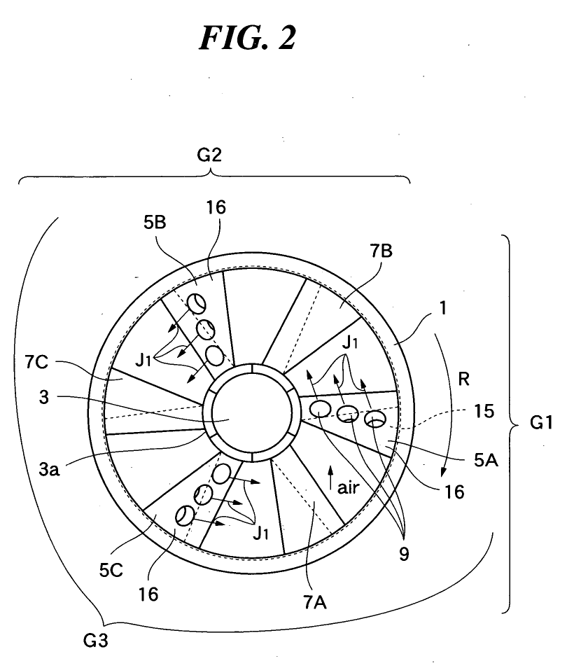

A rotor 3, driven by a rotary engine 2, is rotatably supported within a cylindrical duct 1 with openings at both ends. Rotor 3 is rotated in this embodiment in a direction shown by an arrow R in FIG. 2, but it may be driven to rotate in an opposite direction. Six propeller blades are secured to a circular periphery 3a of rotor 3 with even spacings therebetween, including three apertured blades 5 and three non-apertured blades 7. Apertured blades 5 and non-apertured blades 7 are positioned in alternate arrangement. Each apertured blade 5 has three circular holes 9 each extending in an oblique direction with respect to the direction of rotation of rotor 3. Holes 9 are opened in a three-dimensional manner. Non-apertured blade 7 has no such holes.

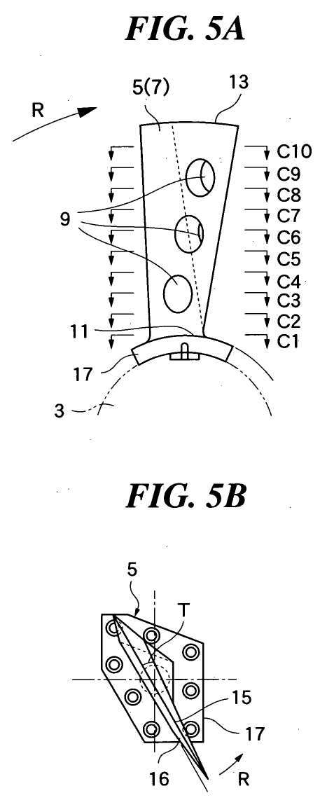

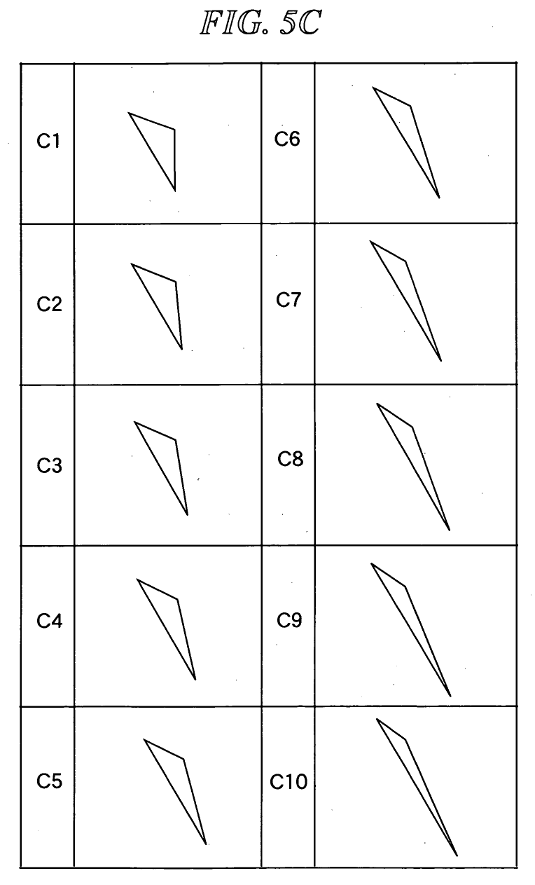

Blades 5, 7 have the same configuration except for having or not having holes 9. Each blade 5, 7 has triangular cross-sections throughout its entire length but its triangular shapes in cross-sections are gradually transformed from a base 11 toward a tip because its width is gradually widen toward tip 13 and it is twisted about a straight axis extending in a lengthwise direction. More specifically, as shown in FIG. 5(C), base 11 of each blade 5, 7 has a cross-section of substantially an equilateral triangle C1, which is gradually flattened and lengthened toward tip 13. Tip 13 has an arcuate, convex end as clearly shown in FIG. 5(A).

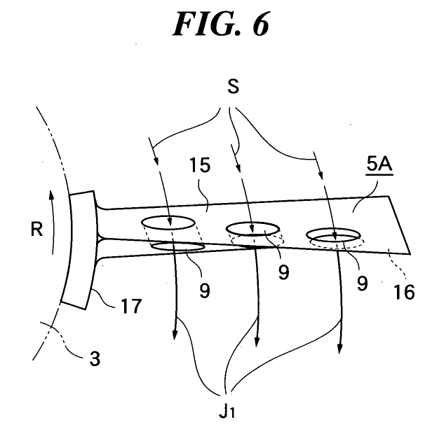

FIG. 5(B) shows a manner in which each blade 5, 7 is secured to rotor 3, which could also be understood from FIG. 6. A wind-receiving surface 15 of blade 5, 7 which is positioned upstream in a direction of rotation of rotor 3 stands aslant at a predetermined acute angle T with respect to the center axis of rotor 3. This angle T is 30 degrees, for example, which may be somewhat smaller than the blade inclination angle in the prior art.

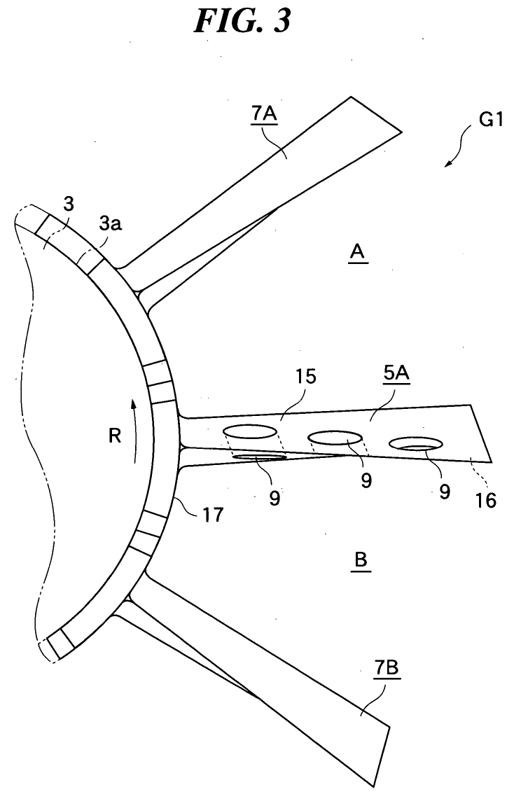

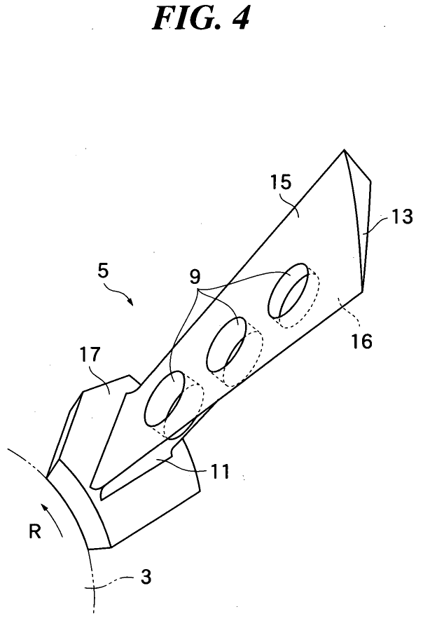

As specifically shown in FIG. 2, apertured blades 5A, 5B, 5C and non-apertured blades 7A, 7B, 7C are arranged alternately in the direction of rotation of rotor 3. Suppose that first apertured blade 5A and two non-apertured blades 7A, 7B adjacent thereto constitute a first blade set G1. Likewise, a second blade set G2 is defined to comprise second apertured blade 5B and its adjacent two non-apertured blades 7B, 7C, and a third blade set G3 is hereby defined to comprise third apertured blade 5C and its adjacent two non-apertured blades 7C, 7A. Moreover, as shown in FIG. 3, a space formed between wind-receiving surface 15 of first apertured blade 5A and non-apertured blade 7A positioned adjacently upstream of said blade 5A in the direction of rotation of rotor 3 is defined as an area A, whereas another space formed between a wind-blowing surface 16 of said apertured blade 5A and the other non-apertured blade 7B is defined as an area B. Likewise, in second blade set G2, a space formed between wind-receiving surface 15 of second apertured blade 5B and non-apertured blade 7B is defined as an area A, whereas another space formed between a wind-blowing surface 16 of said apertured blade 5B and the other non-apertured blade 7C is defined as an area B. Likewise, in third blade set G3, a space formed between wind-receiving surface 15 of third apertured blade 5C and non-apertured blade 7C is defined as an area A, whereas another space formed between a wind-exit surface 16 of said apertured blade 5C and the other non-apertured blade 7A is defined as an area B.

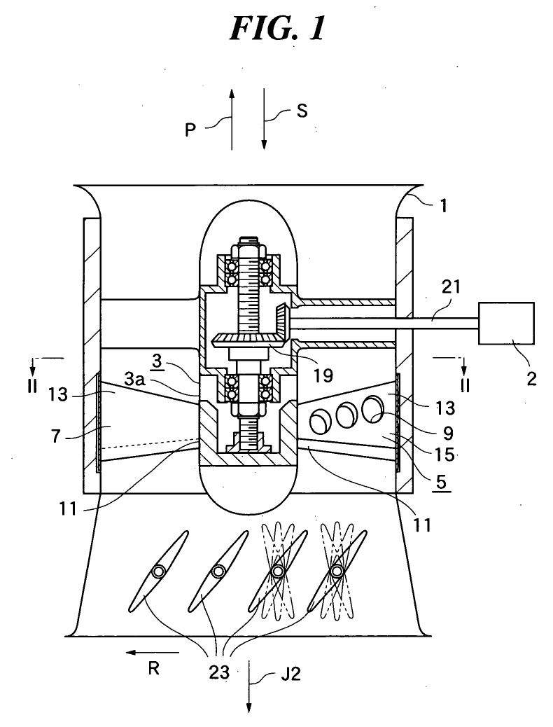

Each blade 5, 7 is secured to a mount 17 having a rounded bottom fitted and secured to the outer periphery of rotor 3. In FIG. 1, a reference numeral 21 denotes a main shaft of rotary engine 2 for transmitting a drive energy generated by rotary engine 2 to a gear 19 of rotor 3. To the bottom of duct 1 are arranged a plurality of stabilizers 23. An arrow S denotes an air stream, J1 and J2 jet streams, P a thrust and R a direction of rotation of rotor 3.

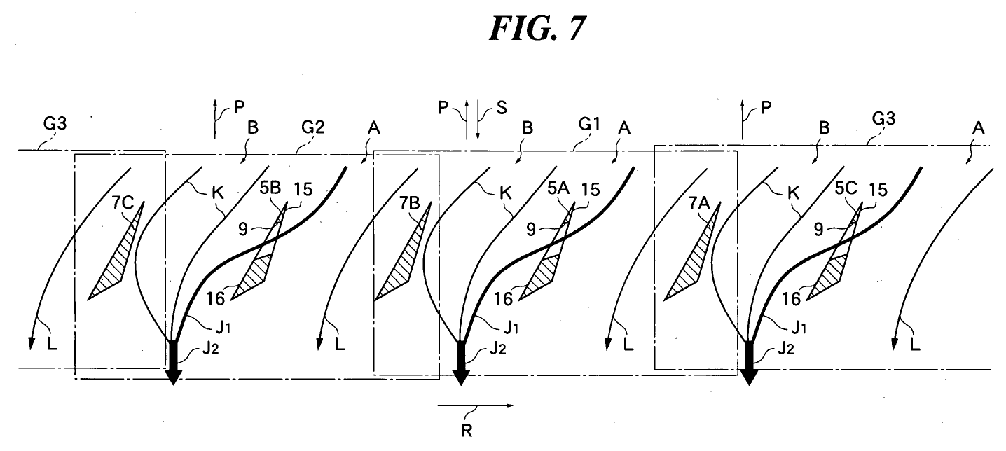

The mechanism of transforming the air stream S entering duct 1 to the jet streams J1, J2 will be described in reference to FIGS. 6 and 7. In FIG. 7, each apertured blades 5A, 5B, 5C has only one hole 9 for the sake of convenience.

When rotary engine 2 is started to drive and rotate rotor 3 in the direction R, air stream S enters duct 1 due to inclination of blades 5, 7. In area A defined between wind-receiving surface 15 of apertured blade 5 (5A, 5B, 5C) and non-apertured blade 7 adjacent to said wind-receiving surface 15, air streams S collide with said wind-receiving surface 15 and pass through the narrow holes 9 so that they are converted to jet streams J1 spouting from said holes 9 and directing toward area B at the opposite side of blade 5. This produces negative pressure in area A. On the contrary, in area B defined between wind-exit surface 16 of apertured blade 5 and non-apertured blade 7 adjacent to said wind-exit surface 16, said non-apertured blade 7 functions as a partition for interrupting the flow of air stream S, resulting in temporary stagnation of the air flow to produce voluminous air flows K moving at relatively slow flow rate. Such a flow rate difference produces a pressure difference between in areas A and B, according to the Bernoulli's principle, which promotes further entry of air streams S into area A having the negative pressure.

Jet streams J1 flowing out of holes 9 entrain and join with air flows K remaining in area B at the exit of area B to produce a second, larger jet flow J2. The pressure in area B is lowered when jet streams J1 flow out of area B, which promotes further entry of air streams S into area B. When jet flow J2 spouts toward the exterior of duct 1, there arises a greater thrust P.

A part of air stream S does not pass through holes 9 but flows directly out of duct 1, which is denoted by a reference numeral L in FIG. 7.

Because apertured blades 5 and non-apertured blades 7 are arranged in alternate relation, wind-receiving surfaces 15 of non-apertured blades 7 are faced to areas A of blade sets G1-G3, whereas the opposite, wind-exit surfaces 16 thereof are faced to areas B of blade sets G1-G3, which makes it possible to produce big jet streams J2 more effectively.

Blades 5, 7 become to stand toward upright with respect to rotor 3, as the attachment angle T of blades 5, 7 to rotor 3 is increased. With the increased angle T, the partitioning function of non-apertured blades 7 will make a greater effect for producing larger-volume air streams K to be entrained by jet streams J1. Non-apertured blades 7 standing at the increased angle T could tend to increase the air resistance when rotor 3 is rotating. However, holes 9 in apertured blades 5 ease such tendency so that an improved thrust P may be obtained. This also means that, in accordance with the present invention, the attachment angle T of blades 5, 7 to rotor 3 may be determined in a wider range.

Although the present invention has been described and illustrated in conjunction with specific embodiments thereof, it should be understood that the present invention is not limited to these embodiments and involves various changes and modifications as far as they are deemed within the spirit and scope of the invention defined in the appended claims. For example, in the described/illustrated embodiment, non-apertured blade 7, for example non-apertured blade 7A, is an element of blade set G1, and at the same time an element of another, adjacent blade set G3. This is not limitative in the present invention. In another embodiment, each non-apertured blade 7 is an element of only one blade set G1-G3 and not an element of another blade set. In such embodiment, the total number of blades 5, 7 may be even or odd depending upon the number of blade sets.

The number of holes 9 formed in apertured blades 5 may be determined at the designers' option. Each blades 5, 7 may be twisted along a curved axis. Base 11 and tip 13 of blades 5, 7 may have any shape rather than of triangle. Rotor 3 may be driven by any suitable drive source including jet engines, reciprocating engines, etc.

Applicability of the present invention is not limited to an aerial car or vehicle and may be widened to anything requiring thrust by rotation of rotor(s) which may include turbines of jet engines and blowers, fans, ventilators with rotating fans or blades.

What is claimed is:

1 A rotary propeller having a rotor rotating in a duct and a plurality of blades secured to said rotor, characterized in that said blades comprise apertured blades and non-apertured blades, one apertured blade cooperating with adjacent two non-apertured blades at opposite sides thereof to form a blade set, jet streams passing through said holes of said apertured blade from an upstream area A of said blade set toward a downstream area B of said blade set, said jet streams entraining air streams in said downstream area B of said blade set to be spouted out of said duct.

2 A rotary propeller according to claim 1 wherein there are provided a plurality of said blade sets.

3 A rotary propeller according to claim 2 wherein said apertured blades and said non-apertured blades are arranged alternately so that one non-apertured blade is an element of one blade set and at the same time is an element of another, adjacent blade set.

4 A rotary propeller according to claim 2 wherein said blade set comprising one apertured blade and two non-apertured blades at opposite sides of said apertured blade are arranged separately.

5 A rotary propeller according to claim 1 wherein said holes in said apertured blade are opened aslant with respect to a direction of rotation of said rotor.

6 A rotary propeller according to claim 1 wherein each blade is secured to said rotor in such manner that a wind-receiving surface positioned upstream of a direction of rotation of sad blade is inclined with respect to a center axis of said rotor at an acute angle.

7 A rotary propeller according to claim 6 wherein said acute angle is about 30 degrees.

8 A rotary propeller according to claim 1 wherein each blade is gradually widen toward a tip thereof.

9 A rotary propeller according to claim 8 wherein each blade has a base of a triangular cross-section.

10 A rotary propeller according to claim 8 wherein each blade has a tip of a triangular cross-section.

11 A rotary propeller according to claim 8 wherein each blade has a base of a cross-section and a tip of another cross-section.

12 A rotary propeller according to claim 8 wherein each blade is twisted about an axis extending in a lengthwise direction.

13 A rotary propeller according to claim 12 wherein said axis is a straight axis.

14 A rotary propeller according to claim 12 wherein said axis is a curved axis.

15 A rotary propeller according to claim 1 wherein each apertured blade has a plurality of said holes.

16 A rotary propeller according to claim 1 wherein said holes are opened in a three-dimensional manner.
